(19) United States
(12) Patent Application Publication
(10) Pub. No.: US 2007/0264525 A1
(43) Pub. Date: Nov. 15, 2007

(54) LUMINESCENT DISPLAY DEVICE, VIEWFINDER DEVICE AND OPTICAL DEVICE

(75) Inventors: Toru Chiba, Tokyo (JP); Takanobu Shiokawa, Kanagawa (JP); Takaomi Sekiya, Tokyo (JP); Yukio Kubota, Saitama (JP); Hiroki Yamazaki, Saitama (JP); Yoshiko Okabe, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/747,452

(22) Filed: May 11, 2007

(30) Foreign Application Priority Data
May 15, 2006 (JP) 2006-135216
Oct. 13, 2006 (JP) 2006-279697

(51) Int. Cl. B32B 19/00

(52) U.S. Cl. 428/690

(57) ABSTRACT

A luminescent display device is provided in a viewfinder device having a viewfinder window for observing an object. The luminescent display device has a substrate a first electrode, an organic layer arranged in sequence on or above the substrate. A sealing member is disposed above the substrate. The organic layer and the first and second electrodes are disposed in a sealed space between the sealing member and the substrate. An absorbent is disposed separately from the substrate within the sealed space, so that the organic layer is interposed between the substrate and the absorbent member.

### BACKGROUND OF THE INVENTION

1. Field of the Invention

The present invention is a luminescent display device provided in a viewfinder device, the viewfinder device, and an optical device incorporating the viewfinder device.

2. Description of the Related Art

Conventionally, it is known that a single-lens reflex camera utilizes an organic electroluminescent device (hereafter referred to as an “EL device”) which is disposed near the object image forming position between a penta prism and a focusing plate. The EL device emits light in order to display a frame, such as a focus frame, in a photographing view area. Additionally, the EL device emits light to display information such as shutter speed, film sensitivity, and an exposure value, at the exterior side of the photographing view area, as shown in U.S. Pat. No. 6,738,577 and U.S. Pat. No. 6,468,676.

As shown in U.S. Pat. No. 6,738,577, the electrode of the EL device in the viewfinder device has a transparent electrode portion and non-transparent electrode portion. The non-transparent electrode portion is arranged in the photographing view area and is arranged in the form of a focus frame. The non-transparent electrode blocks the light of an object image so as to display the non-transparent focus frame in the photographing view. Due to this, the frame line which is usually drawn on the focusing plate can be omitted.

The EL device has an organic layer interposed between an anode and cathode disposed in a sealed space, this space being formed between a transparent substrate and a sealing member. An absorbent is usually provided in the sealed space in order to remove moisture content which exists in the sealed space or is deposited on a component of the EL device, such as the electrodes or the substrate.

The light from of an object image is made incident to the viewfinder window through the EL device in order to observe the object. However, conventionally, the position and the material of the absorbent of the EL device provided in the viewfinder device are not improved sufficiently. Therefore, the absorbent may block the light of the object image, resulting in the observation of the object being obstructed by the absorbent.

### SUMMARY OF THE INVENTION

Therefore, an object of the present invention is to provide a luminescent display device which prevents the absorbent from obstructing the observation of the object.

According to the present invention, there is a luminescent display device, which is provided in a viewfinder device having a viewfinder window for observing an object. The luminescent display device has a substrate, a first electrode that is disposed on or above the substrate, an organic layer including a light-emitting material that is disposed on or above at least apart of the first electrode, and a second electrode. At least apart of the second electrode is disposed on or above the organic layer. The organic layer is caused to emit a light by applying a voltage between the first and second electrodes.

Further, the luminescent display device has a sealing member that is disposed above the substrate so as to form a sealed space between the sealing member and the substrate. The organic layer and the first and second electrodes are disposed in the sealed space. The light of the object image is incident to the view finder window through the sealing member and the substrate, and the light emitted by the organic layer is incident to the viewfinder window through one of the substrate and the sealing member so as to display an image that is observed at the viewfinder window. The luminescent display device further has an absorbent which is disposed separately from the substrate within the sealed space, so that the organic layer is interposed between the substrate and the absorbent member.

### BRIEF DESCRIPTION OF THE DRAWINGS

The objects and advantages of the present invention will be better understood from the following description, with reference to the accompanying drawings in which:

FIG. 1 is a side view showing the viewfinder device of the present invention;

FIG. 2 is a plan view of the luminescent display device in accordance with a first embodiment of the present invention;

FIG. 3 is a sectional view of the luminescent display device in accordance with the first embodiment;

FIG. 4 is a plan view of the luminescent display device in accordance with a second embodiment;

FIG. 5 is a plan view of apart of the luminescent display device in accordance with the second embodiment;

FIG. 6 is a sectional view of the luminescent display device in accordance with the second embodiment;

FIG. 7 is a plan view of the luminescent display device in accordance with a third embodiment of the present invention;

FIG. 8 is a sectional view of the luminescent display device in accordance with the third embodiment;

FIG. 9 is a plan view of the luminescent display device in accordance with a fourth embodiment of the present invention;

FIG. 10 is a plan view of the luminescent display device in accordance with a fifth embodiment of the present invention;

FIG. 11 is a sectional view of the luminescent display device in accordance with the fifth embodiment;

FIG. 12 is a sectional view of the luminescent display device in accordance with a sixth embodiment of the present invention;

FIG. 13 is a sectional view of the luminescent display device in accordance with a modified embodiment of the sixth embodiment;

FIG. 14 is a sectional view of the luminescent display device in accordance with a seventh embodiment of the present invention;

FIG. 15 is a plan view of the luminescent display device in accordance with an eighth embodiment of the present invention; and

FIG. 16 is a sectional view of the luminescent display device in accordance with the eighth embodiment.

### DESCRIPTION OF THE PREFERRED EMBODIMENTS

The present invention will be described below with reference to the embodiments shown in the drawings.

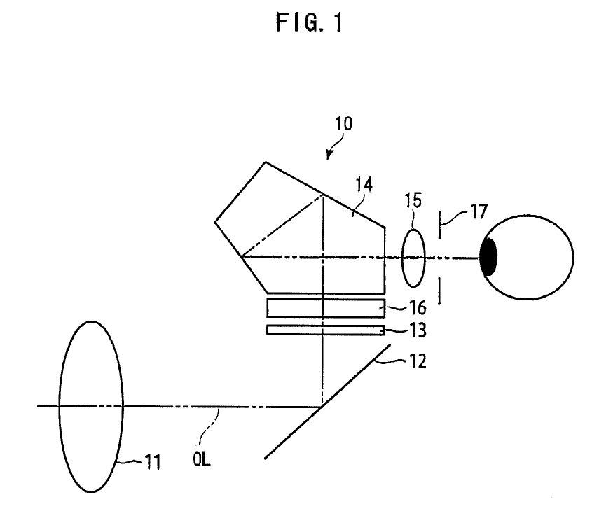

FIG. 1 shows the viewfinder device in the first embodiment of the present invention. Moreover, although a case in which the viewfinder device is applied to a single-lens reflex camera is described below, the viewfinder device can be applied to other optical devices such as a compact camera and a microscope.

The viewfinder device 10 has an objective lens it, a quick return mirror 12, a focusing plate 13, a penta prism 14, an eyepiece lens 15, a luminescent display device 16, and a viewfinder window 17.

An object light OL, corresponding to the light of the object image, reflected from an object, is made incident onto the focusing plate 13 through the objective lens 11 and the quick return mirror 12. The object light OL is focused onto the focusing plate 13 so as to form the image of the object thereon. The object light OL is reflected twice at the penta prism 14 and is incident onto the viewfinder window 17 through the eyepiece lens 15, in order that the image of the object can be observed.

When the release switch is operated, the quick return mirror 12 is moved so as to remove it from the optical path of the object light OL. In this case, the object light OL is directed to a film or a CCD and, which it exposes.

The luminescent display device 1 is the EL device. The luminescent display device 16 is located at the intersecting plane which intersects the optical path of the object light OL between the focusing late 13 and the pentaprism 14. Namely, the luminescent display device 16 is disposed near the object image forming position on the optical path. The light emitted by the luminescent display device 16 is also made incident into the viewfinder window 17 through the penta prism 14 and the eye piece lens 15. Alternatively, the luminescent display device 16 may be disposed between the quick return mirror 12 and the focusing plate 13.

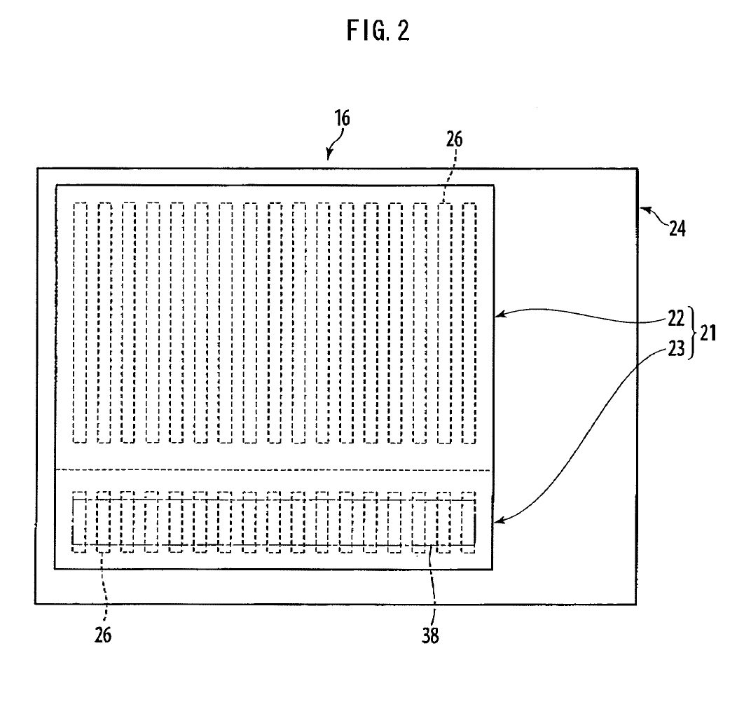

FIG. 2 is a schematic plan view of the luminescent display device 16. The luminescent display device 16 has a rectangular viewfinder area 21 and an out-of-view area 24 in the form of a rectangular frame. The out-of-view area 24 surrounds the viewfinder area 21. The viewfinder area 21 is viewable from the viewfinder window 17. The out-of-view area 24 is not viewable from the viewfinder window 17.

The rectangular viewfinder area 21 is composed of a rectangular photographing view area 22 for observing an object, and a rectangular information display area 23 which is situated below and adjoined to the photographing view area 22. The object light OL is incident to the photographing view area 22 and travels through it, meaning the object can be observed through the photographing view area 22. On the other hand, the object light OL is not incident to the information display area 23, meaning the object can not be not observed through the information display area 23.

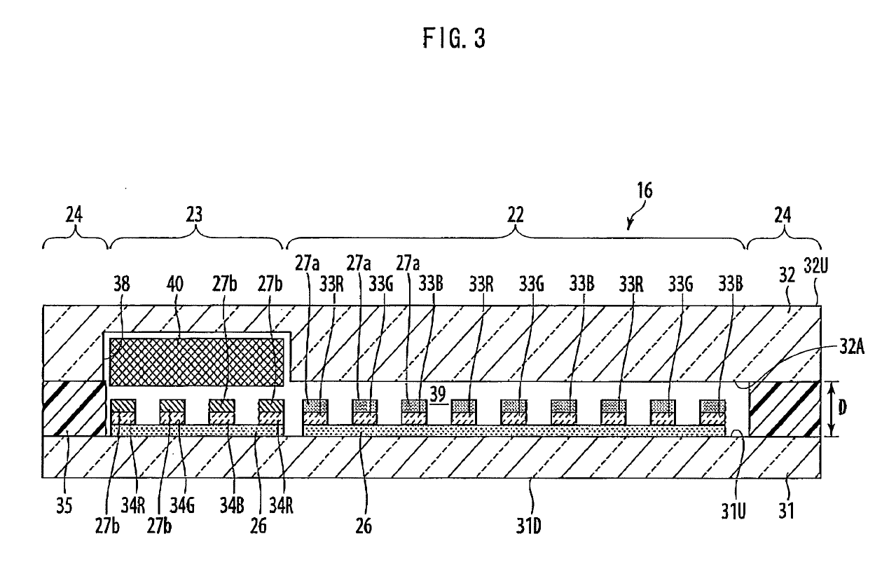

FIG. 3 is a cross-section view of the luminescent display device 16. The luminescent display device 16 has a transparent substrate 31, a sealing member 32, which is disposed above the transparent substrate 31, anodes 26, first and second organic layers 33R, 33G, 33B, 34R, 34G, and 34B, and first and second cathodes 27a and 27b, and an absorbent 40 which is provided on the sealing member 32. The anodes 26, first and second cathodes 27a and 27b, and the first and second organic layers 33R, 330, 33B, 34R, 340, and 34B are disposed between the substrate 31 and the sealing member 32.

The luminescent display device 16 is arranged with the substrate 31 on the eyepiece side and the sealing member 32 on the objective side. The light emitted by the organic layer is made incident into the viewfinder window 17 through the substrate 31. The object light OL is incident into the viewfinder window 17 through the sealing member 32 and the substrate 31.

The transparent substrate 31 and the sealing member 32 are formed of a transparent material such as glass or synthetic resin, and are in the form of a plate. The sealing member 32 is bonded to the substrate 31 with a sealant 35 which is disposed on a surrounding portion of the upper surface 31U of the substrate 31 so that a sealing space 39 is formed between the substrate 31 and the sealing member 32. The surrounding portion, namely the sealant 35, which surrounds the viewfinder area 21, is arranged in the out-of-view area 24. The anodes 26 and the cathodes 27a and 27b and the organic layer are disposed within the sealing space 39 so that they are sealed in by the sealing member 32 and the sealant 35. Furthermore, because the height of the sealant 35 (namely, a distance D as described below) is not less than 25 μm, it is difficult to construct the sealant 35 using only an adhesive. Therefore, the sealant 35 preferably has a spacer, which is bonded to both the substrate 31 and sealing member 32 with the adhesive.

A plurality of anode 36 are lamintated on the upper surface 31U of the substrate 31 in the photographing view area 22. The anodes 26 are rectangular in shape, arranged parallel to each other, elongating in the vertical direction, as shown in FIG. 2. The anodes 26 are formed of a transparent conductive metallic compound such as ITO (Indium Tin Oxide), ATO (antimony doped tindioxide), and ZnO (zincoxide). In the photographing view area 22, the first organic layers 33R, 33G, and 33B, are laminated on the upper surface of each anode 26. These first organic layers 33R, 33G, and 33B are repeatedly arranged in this order on the same anode 26 in the vertical direction, and repeatedly arranged in this order in the horizontal direction on different anodes 26. The first organic layers 33R, 33C, and 33B have a hole transporting layer, a light-emitting layer formed of a light-emitting material, and an electron transporting layer layered in sequence from the anode 26 side. The first organic layers 33R, 33G, and 338 emit red, green, and blue light, respectively, when a voltage is applied between the anode 26 and the cathode 27a. The first cathode 27a is laminated on top of each of the first organic layers 33w, 33C, and 333. The first cathode 27a is a transparent electrode so as not to obstruct the light passing through the luminescent display device 16.

The first cathode 27a can be formed by using only a transparent conductive metallic compound such as ITO, ATO, and ZnO. Howevert it preferably has a two-layer structure. Namely, the first cathode 27a preferably has a first layer which is laminated on the organic layer, and a second layer which is laminated on the first layer. The first layer is formed of a non-transparent metallic material such as aluminum, indium, magnesium, calusium, titanium, yttrium, lithium, or an alloy of two or more of these. The second layer is formed of a transparent conductive metallic compound such as ITO, ATO, or ZnO. The thickness of the first layer is not more than 100 angstroms. Because of this thin first layer, it becomes adequately transparent, even though it is formed of non-transparent material. Consequently, the first cathode layer 27a is transparent. Preferably, an electron injection layer is laminated between the first layer and the organic layer. The electron injection layer is formed of LiF, for example, and its thickness could be 7 angstroms, for example. Further, the thickness of the second layer could be 2000 angstroms, for example.

The work function of the first cathode layer 27a is relatively high if it is only formed of a transparent conductive metallic compound. However, the work function is relatively low if it uses a two-layer construction and the first layer is formed of the metallic material having a relatively low work function.

In the information display area 23, a plurality of the anodes 26 which are aligned as rectangles elongated in the vertical direction are laminated on the upper surface 31U, and the second organic layers 34R, 34G, 34B are laminated thereon, similar to those in the photographing view area 22. The second organic layers 34P, 34G, and 34B emit red light, green lights and blue light, respectively, when a voltage is applied between the anode 2G and the cathode 27b.

The second cathode 27b is laminated on each of the second organic layers 34R, 34G, and 34B. It is not necessary to allow the object light OL to pass through the information display area 23 because the object light OL is not incident in the information display area 23. Therefore, the second cathodes 27b are a non-transparent electrode portion formed of a non-transparent material such as the ones described above. The efficiency of electron injection of the non-transparent electrode portion is higher than that of the transparent electrode portion because the work function of the non-transparent electrode portion is relatively low. Consequently, the luminous efficiency of the second organic layers 34R, 34G, 34B is higher than that of the first organic layers 33R, 33G, 33B.

Further, the first or second cathodes 27a or 27b, arranged in the same line in the horizontal direction, may be connected to one another and formed as one integral body. The first and second,cathodes 27a and 27b and the anodes 26 are connected to the electrical power source through the transparent cathode or transparent anode line (not shown in FIGS.).

Further, one or more layers may be interposed between the anode 26 and the substrate 31, or/and between the anode and the organic layer, or/and between the organic layer and the cathode 27a or 27b.

The plurality of first organic layers 33R, 33G, 338, which are arrayed in the photographing view area 22, emit light to display a full-color image. In addition, because all of the organic layers and the electrodes in the photographing view area 22 are formed of transparent material, the luminescent display device 16 does not obstruct the object light OL in the photographing view area 22. Therefore, when the first organic layers 33R, 33G, and 33B do not emit light, object light OL which is incident into the photographing view area 22 is observed as the image of the object at the viewfinder window 17 of course, the display image which is produced by the first organic layers 33R, 33G, and 33B, and the object image, can be observed simultaneously.

The plurality of second organic layers 34R, 34G, and 34B, which are arrayed in the information display area 23, emit light to display a full-color image. On the information display area 23, information which is related to the photography conditions such as shutter speed, film sensitivity, and an exposure value is displayed by the second organic layers 34R, 34G, and 34B.

The sealing member 32 has a bottom surface (first facing surface) 32A which is orientated towards the upper surface (second facing surface) 31U of the transparent substrate 31, and an upper surface (first opposite surface) 32U which is opposite surface of the sealing member 32A to the bottom surface 32A. Further, the substrate 31 has a bottom surface (second opposite surface) 31D which is the opposite surface of the substrate 31 to the upper surface 31U.

The sealing member 32 has a recess 38 which is indented in the first facing surface 32A. This recess is formed by a blasting method such as a sandblasting method, so the surface of the recess 38 becomes a frosted surface, namely a non-transparent surface. The absorbent 40 is disposed within the recess 38, and may be bonded to the inner surface of the recess 38 with adhesive.

The absorbent 40 is able to absorb moisture existing in the sealed space 39, and moisture deposited the components of the device 16, such as the electrodes, the sealing member 32, and the substrate 32. As for the absorbent 40, a non-transparent material such as barium oxide, calcium oxide, a molecular sieve, silica gel or a transparent material such as an absorbent including an aluminum complex as shown in formula (1) can be used. An absorbent including an aluminum complex is commercially available as OleDry (Registered trade mark in Japan, manufactured by Futaba Corporation).

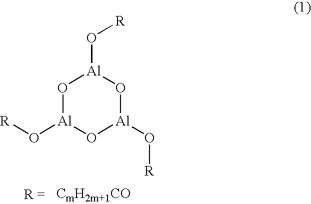

Due to the non-transparent surface of the recess 38, the recess 38 might obstruct the observation of the object image, if the recess 38 was viewable. Similarly, an absorbent formed with non-transparent material might also obstruct the observation of the image of the object. Therefore, it is necessary for the recess 38 and the absorbent 40 to be hidden from the viewfinder window 17 (namely, from the substrate side).

In this embodiment, the recess 38 and the absorbent 40 are disposed separately from the substrate 31 in order to interpose the second organic layers 34R, 34G, and 34B and the second cathode 27b between the substrate 31 and the absorbent 40. Due to this, when the luminescent display device 16 is observed from the substrate side, the recess 38 is hidden by the non-transparent portion of the second cathode 27b in the information display area 23. Therefore, when the viewfinder area 21 is observed from the viewfinder window 17, almost all of the recess 38 and the absorbent 40 are blocked from view by the non-transparent cathode portion, so that the recess 38 and the absorbent 40 do not obstruct the observation of the object.

In addition, in this embodiment, the recess 38 and the absorbent 40 are located in the information display area 23 where object light OL is not incident and does not pass through. Therefore, they do not obstruct the observation of the object. Further, the absorbent 40 is located in the same area as the organic layer is arranged, so it does not demand any the extra area for its location. This results in a possible reduction of the size of the luminescent display device 16. Further, the recess 38 is a rectangle in a location corresponding to the location of the information display area 23, in the view from the substrate side.

Furthermore, in this embodiment, because the absorbent 40 is arranged in the recess 38, it is not necessary for it to be arranged in the space between the facing surface 32A and the upper surface 31U; this allows the distance D between the facing surface 32A and the upper surface 31U to be small so that the thickness of the luminescent display device 16 can be reduced. However, if the distance D is too short, there is a possibility that interference fringes can be generated by the light reflected at the upper surface 31U and the first facing surface 32A. Therefore, the distance D is preferably not less than 25 μm. Further, interference fringes may be generated by optical interference when the distance D is not uniform across its width with a high degree of optical accuracy.

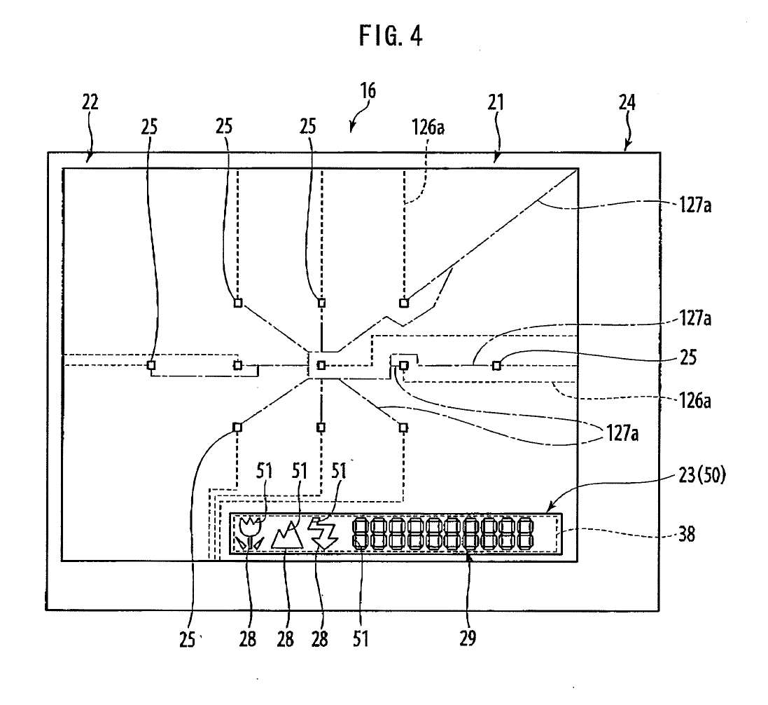

FIGS. 4-6 show the luminescent display device 16 in the second embodiment. In the first embodiment, the luminescent display device 16 is driven by a passive matrix method, for example. However, the luminescent display device 16 can be driven by a segment method and a static method in this embodiment.

In the second embodiment, the luminescent display device 16 has a viewfinder area 21 and an out-of-view area 24, similar to the first embodiment. In this embodiment, the rectangular information display area 23 is located in the lower right area, extending in the horizontal direction, within the viewfinder area 21. The rest of the area in the viewfinder area 21 except for the information display area 23 is defined as the photographing view area 22, which object light is incident to and passes through.

The luminescent display device 16 has a character display portion 29 for displaying a character, a symbol mark, an icon, a figure, or a sign, and a segment display portion 29 for displaying a letter, in particular a number, in the information display area 23. In this embodiment, three character display portions 28 for displaying a symbol mark and a segment display portion for displaying numbers are provided in the information display area 23.

The information display area 23 is covered by a shading member 50, and is defined as a shading area. The object light and the light emitted by the luminescent display device 16 toward the viewfinder window 17 is obstructed by the shading member 50 except for the light transmitted through an opening 51 as described below.

The luminescent display device 16 has a plurality of focusing points 25 in the photographing view area 21. Sine focusing points 25 are arrayed in the center area of the photographing view area 21 and a focusing point 25 is arranged on the light and right of the center area, respectively.

The luminescent display device 16 has anodes 126, which are disposed on the substrate 31, organic layers 133 and 134 which are disposed on at least a part of the anode 126, and cathodes 127. At least a part of the cathode 127 is disposed on the organic layers 133 and 134.

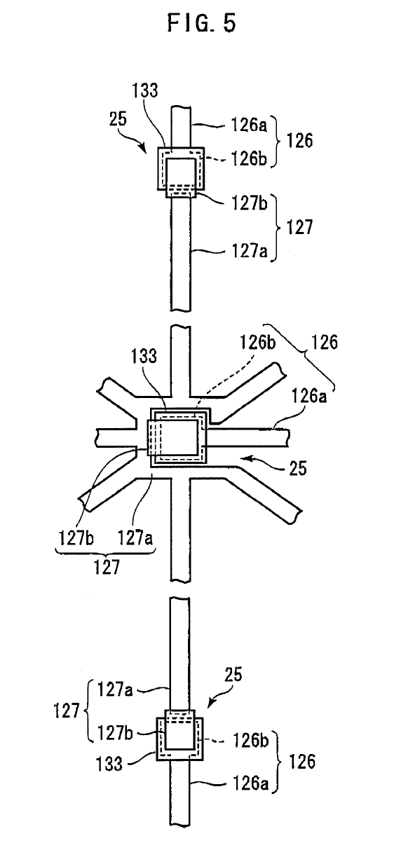

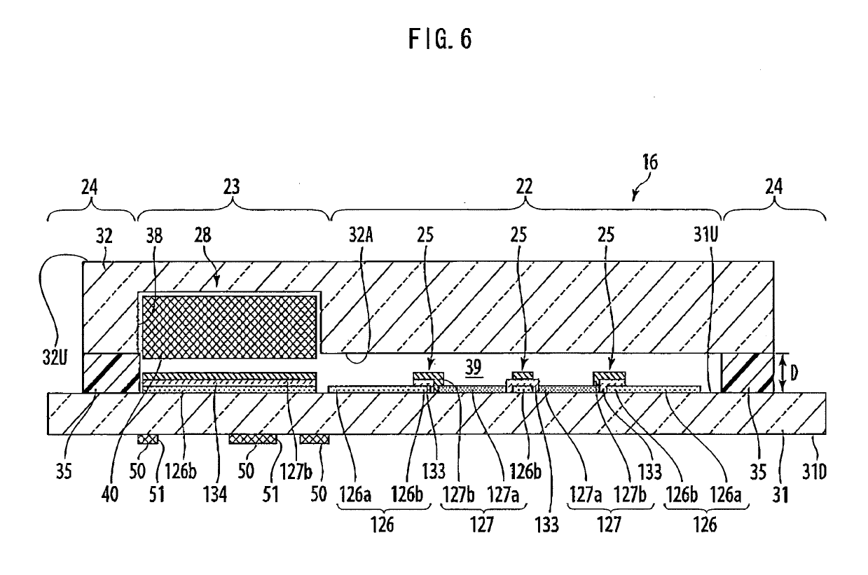

Each focusing point 25 is composed of the first organic layer 133 (referred to in FIGS. 5 and 6) all of which are laminated separately from one another. When an object or objects are photographed using the auto-focus, the distances between the object seen at each focusing point 25 and the camera are measured, and the closest object is focused on. The focusing point 25 where the focused object is seen emits light.

The character display portions 28 and the segment display portion 29 are composed of the second organic layer 134(referred to in FIGS. 5 and 6). Each character display portion 28 is composed of the second organic layer 134, all of which are laminated separately from one another. The segment display portion 29 has a plurality of segments, each segment is composed of the second organic layer 134, all of which are laminated separately from one another. The segment display portion 29 displays numbers by emission of light from Lo the second organic layer 134.

The shading mask 50 is disposed on the eyepiece side of the luminescent display device 16 and overlaps onto the information display area 23. As shown in FIG. 6, the shading mask 50 is laminated on the bottom surface 31D of the substrate 31. The shading mask 50 has the opening 51 formed in the shape of the character or the segment. When the second organic layer 133 emits light, the light corresponding to the shape of the character or the segment is emitted from the opening 51 so that the character or number is observed in the viewfinder window 17.

In this embodiment, the anode 126 is composed of an anode line 126a and an anode terminal 126b. The cathode 127 is composed of a cathode line 127a and a cathode terminal 127b. As shown in FIGS. 4 and 6, an anode line 126a and a cathode line 127a are laminated on the substrate 31. In FIG. 4, the anode line 126a is indicated as a dotted line, and the cathode line 127a is indicated as a dashed-dotted line, but the anode and cathode lines 126a and 127b in the out-of-view area 24 are not indicated in FIG. 4.

Eleven anode lines 127a extend from the out-of-view area 24 to a focusing point 25, separately. One cathode line 127a extends from the out-of-view area 24 to the viewfinder area 21 and branches in the area 24 to eleven cathode lines 127a which extend to each focusing point 25. The eleven anode lines 126a and one cathode line 127a in the out-of-view area 24 are connected to the electric power source. In this embodiment, the electric current which is input to each anode line 126a is adjusted independently, so that the emission of light from the first organic layers 133 is controlled independently. Similarly, the anode and cathode lines extend to each of the character display portions 28 and each segment in the segment display portion 29; the emission of light in each character display portion 28 and the emission of light in each segment are controlled independently.

The end of each anode line 126a in the viewfinder area 22 is formed in a substantially square shape at each focusing point 25 and is defined as an anode terminal 126b. Namely, the anode 126 is composed of the anode line and terminal 126a and 126b which are formed as one body integral.

In the photographing view area 22, the first organic layer 133 is laminated on the anode terminal 126b to protrude from every side of the anode terminal 126b so that every side of the first organic layer 133 is laminated onto the substrate 31. On the first organic layer 133, a substantially rectangular cathode terminal 127b is laminated to protrude from at least one side of the first organic layer 133, so that at least one side of the cathode terminal 127b is laminated onto the cathode line 127a. Due to this, the cathode terminal 127b is connected to the cathode line 127a. Namely, the cathode 127 is composed of the cathode line 127a and the cathode terminal 127b which is formed separately from the cathode line 127a.

In the character display portion 28 and the segment display portion 29, a second organic layer 134 and the cathode terminal 127b are laminated in sequence onto the anode terminal 126b, similarly. These anode and cathode terminals 126b and 127b are connected to the anode and cathode lines, similar to that in the focusing point 25.

The anode 126 (the anode line 126a and the anode terminal 126b) and the cathode line 127a are formed of a transparent conductive metallic compound such as ITO, ATO, or ZnO. The anode and cathode lines 126a and 127a are arranged in the photographing view area 22, but they are composed of transparent electrodes, so that they do not obstruct the observation of the object.

The cathode terminal 127b is formed of a non-transparent metallic material as described above in order to prevent the efficiency of electron injection from decreasing. Due to this, the cathode terminal 127b is composed of a non-transparent electrode which is arranged in the photographing view area 22. The object light is blocked by the cathode terminal 127b of the focusing point, so that the area where the cathode terminal 127b is arranged does not transmit object light OL. Therefore, the cathode terminal 127b is viewable from the viewfinder window 17 as the dark point used for indicating the position of the focusing point 25, in order that it is not necessary to draw the dark point on the focusing plate.

The first and second organic layers 133 and 134 have a similar structure to that of the first embodiment so as to emit red, green, blue, or white light when a voltage is applied between the anode and cathode terminals 126b and 127b.

The recess 38 is provided on the first facing surface 32A of the sealing member 32 and the absorbent 40 is disposed within the recess 38, similar to the first embodiment. The inner surface of the recess 38 is a frosted surface, which obstructs the transmission of the light.

In this embodiment, the absorbent 40 and the recess 38 are arranged in the information display area 23, and are disposed separately from the substrate 31 so as to interpose the second organic layer 134a and the cathode terminal 127b between the absorbent 40 (the recess 38) and the substrate 31. Therefore, when the viewfinder area 21 is viewed from the viewfinder window 17, some parts of the recess 38 and the absorbent 40 are blocked from view by the non-transparent cathode portion.

The other parts of the recess 33 and the absorbent 40 are not blocked by the non-transparent cathode portion, because the non-transparent cathode portion is laminated only onto some parts in the information display area 23. However, in this embodiment, the information display 23 is overlapped by the shade mask 50, so that the otherwise visible parts of the recess 38 and the absorbent 40 are blocked by the shade mask 50.

Further, the shade mask 50 has an opening 51, however the opening 51 does not overlap with the otherwise visible parts, but overlaps the non-transparent cathode portion in order to transmit the light emitted by the organic layer. Therefore, all of the recess 38 and the absorbent 40 are overlapped by either the shade mask 50 or the non-transparent electrode. Due to this, the recess 38 and the absorbent 40 are completely blocked from view by either the shade mask 50 or the non-transparent electrode.

In this embodiment, the recess 38 and the absorbent 40 do not obstruct the observation of the object. In addition a reduction of the size of the luminescent display device 16 is achieved, similar to the first embodiment.

Further, some areas are overlapped by the cathode terminal 127b (non-transparent electrode) in the photographing view area 22. But these areas are very small, so that the recess 38 and the absorbent 40 are not arranged at those areas.

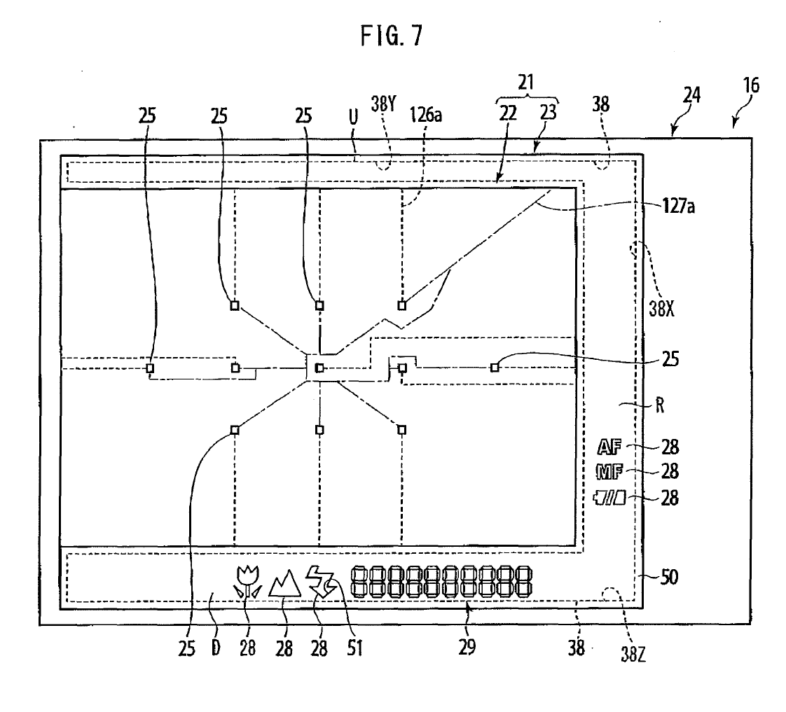

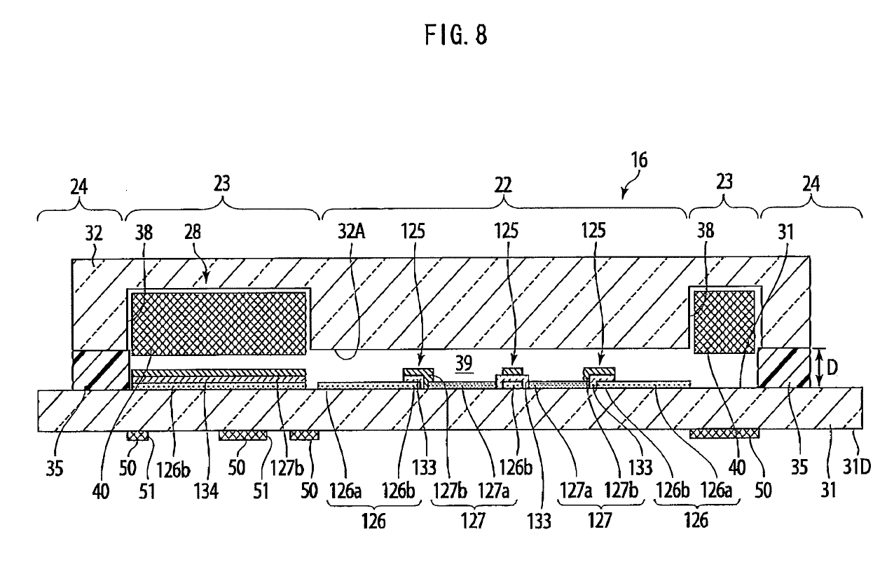

FIGS. 7-8 show the luminescent display device in the third embodiment. In the second embodiment, the information display area 23 is arranged inside the photographing view area 22. However, in this embodiment, the information display area 23 is arranged outside the photographing view area 22. The difference of this embodiment from the second embodiment will be explained below.

As shown in FIG. 8, a shade mask 50 is laminated on a part of the bottom lower surface 31D of the substrate 31. When the luminescent display device 16 is viewed from the substrate side as shown in FIG. 7, the area which the shademask 50 overlaps is defined as the information display area 23, similar to the second embodiment.

The shade mask 50 overlaps the upper perimeter area U, lower perimeter area D, and right perimeter area R of the viewfinder area 21, so that the upper, lower, and right perimeter areas U, D, and R are defined as the information display area 23. Namely, the information display area 23 is composed of the right perimeter area R extending in the vertical direction and the upper and lower perimeter areas U and D extending in the horizontal direction. Further, the right ends of the upper and lower perimeter areas U and D are connected to the upper and lower ends of the right perimeter R.

The segment display portions 29 and some of the character display portions 28 are arranged in the lower perimeter area U, and the rest of the character display portions 28 are arranged in the right perimeter area R. Further, the second organic layer 134 is arranged in each character display portion 28 and in each segment of the segment display portions 29, similar to the second embodiment.

When the luminescent display device 16 is viewed from the substrate side as shown in FIG. 8, the opening 51 of the shade mask 50 overlaps the second organic layer 134. The opening 51 is patterned in a predetermined shape, so that the light emitted by the second organic layer 134 is incident to the viewfinder window 17 through the opening 51 as the character and number display images, similar to the first embodiment.

The recess 38 where the absorbent is disposed is arranged in the information display area 23, similar to the second embodiment. The recess 38 has a shape corresponding to the shape of the information display area 23. Therefore, the recess 30 has a first straight groove 38X extending in the vertical direction in the right perimeter area R, and second and third straight grooves 38Y, 38Z extending substantially vertically to the first straight groove at the upper and lower perimeter areas U and D, respectively. The right end of the second groove 38Y connects to the upper end of the first straight groove 38X and the right end of the third groove 38Z connects to the lower end of the first straight groove 38X. The absorbent 40, which is disposed within the recess 38, is arranged in the upper, lower, and the right perimeter areas U, X, and R.

Because the recess 38 is arranged on the outside of the photographing view area 22, the area occupied by the recess 38 can be enlarged easily, so that the amount of absorbent can be increased. Further, the recess 38 is arranged in the information display area 23, used for displaying the information; therefore, it is not necessary to provide an extra area for arranging the recess 38.

In this embodiment, the recess 38 and the absorbent 40 are overlapped by the second organic layer 134 (namely, non-transparent electrode) or shade mask 50, so they can not be observed from the viewfinder window 17, similar to the second embodiment.

Further, the shade mask 50 may overlap onto the left perimeter area L of the viewfinder area 21, so that the shade mask 50, namely the information display area 23 is formed as the rectangular frame shape. In this case, the recess 38 may have a fourth straight groove, which is arranged at the left end area L of the viewfinder area 21. The upper end and lower end of the fourth straight groove are connected to the left ends of the second and third straight groove 38Y and 38Z, respectively, so that the recess 38 is formed as a rectangular frame shape.

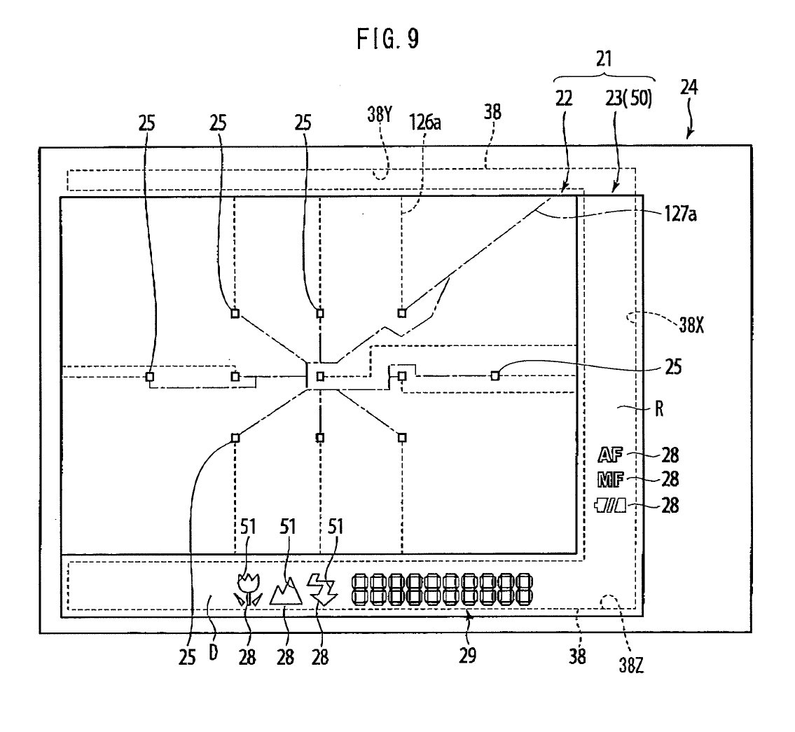

FIG. 9 shows the luminescent display device in the fourth embodiment. In the third embodiment, the recess 38 and the absorbent are arranged only in the information area 23. However, in this embodiment, the recess 38 and the absorbent are arranged in both the information area 23 and the out-of-view area 24. The difference of this embodiment from the third embodiment will be explained below.

As shown in FIG. 9, the shade mask 50, having an L-shaped form, overlaps the right and lower perimeter areas R and D, so that the information display area 23, which has an L-shaped form, is composed of the right perimeter area R and the lower perimeter area D of the viewfinder area 21. The out-of-view area 24, which is in the form of a rectangular frame, surrounds the viewfinder area 21, similar to that of the third embodiment.

In this embodiment, the recess 38 has the first, second, and third straight grooves 38X-38Z, similar to the third embodiment. The first and third straight grooves 38X and 38Z are arranged in the right and lower perimeter areas R and D. The second straight groove 38Y is arranged at the upper area of the out-of-view area 24.

In this embodiment, some part of first and third grooves 38X and 38Z and the absorbent 40 within them are blocked from view by the shade mask 50 or the non-transparent electrode. The second groove 38Y and the absorbent 40 within it are arranged in the out-of-view area 24, so that the recess 38 and the absorbent 40 are not visible from the viewfinder window 17. Further, in this embodiment, all the recess 38 and the absorbent 40 may be arranged in the out-of-view area 24.

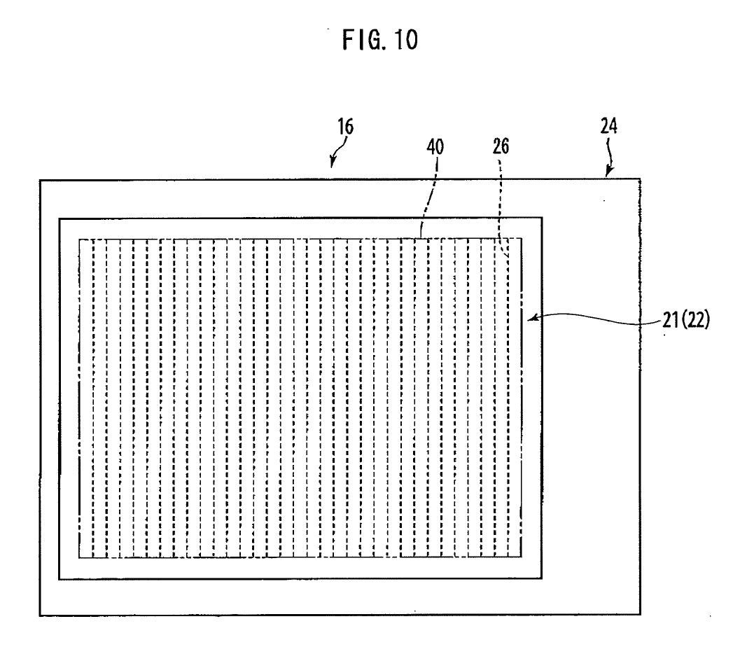

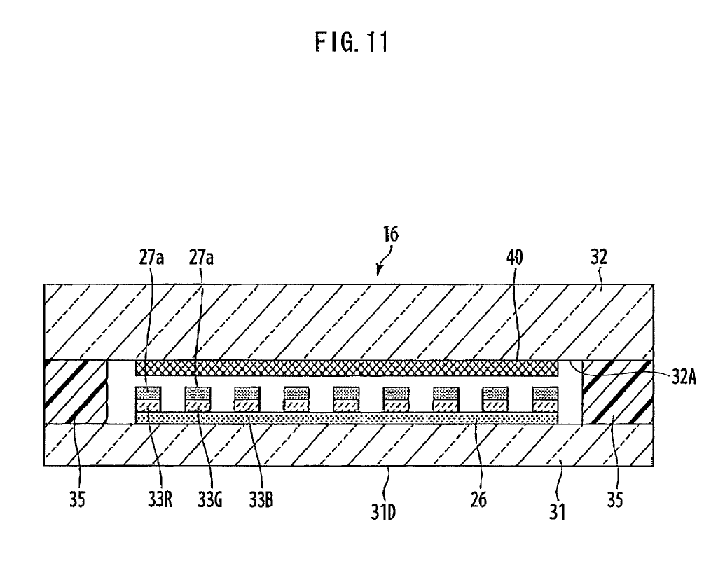

FIGS. 10 and 11 show the luminescent display device in the fifth embodiment. In this embodiment, a recess 38 is omitted, and the absorbent 40 is covered on the first facing surface 32A of the sealing member 32. The difference of the fifth embodiment from the first embodiment will be explained below.

In this embodiment, the luminescent display device 16 has a viewfinder area 21 and an out-of-view area 24, similar to the first embodiment, but the viewfinder area 21 does not have an information display area and consists of a photographing view area 22.

Xn the photographing view area 22 the plurality of anodes 26, the first organic layers 33R, 33G, and 33B, and the first cathode 27a are laminated on the substrate 31, similar to in the first embodiment. The absorbent 40 is adheres to the first facing surface 32A, and is disposed separately from the substrate 31, so that the first organic layers 33R, 33G, and 33B, the anode 26, and the cathode 27a can be interposed between the substrate 31 and the absorbent 40. Namely, the absorbent 40 overlaps the first organic layers 33R, 33G, and 33B.

The first organic layers 33R, 33G, and 33B, the anode 26, and the cathode 27a are formed of a transparent material, similar to the first embodiment. Further, the absorbent 40 is a transparent material such as the absorbent including aluminum complex as described above. Therefore, object light is incident to the viewfinder window 17, and not obstructed by the cathode, the organic layers, the anode, and the absorbent in the photographing view area 22. Further, the organic layers 33R, 33G, and 33B emit red, green, and blue light, respectively, so that the luminescent display device 16 can display full-color image. Namely, the photographing view area 22 in this embodiment is not only used for displaying an image but also used for observing the object.

In this embodiment, the absorbent 40 overlaps the organic layer, so it is not necessary to provide extra space for arrangement of the absorbent 40, which reduces the size of the luminescent display device 16.

Further, in this embodiment, the luminescent display device 16 is arranged with the substrate 31 on the eyepiece side, similar to the first embodiment. However, the luminescent display device 16 may be arranged with the substrate 31 on the objective side and the sealing member 32 on the eyepiece side. In this case, the light emitted by the organic layer is incident into the viewfinder window 17 through the absorbent 40 and the sealing member 32.

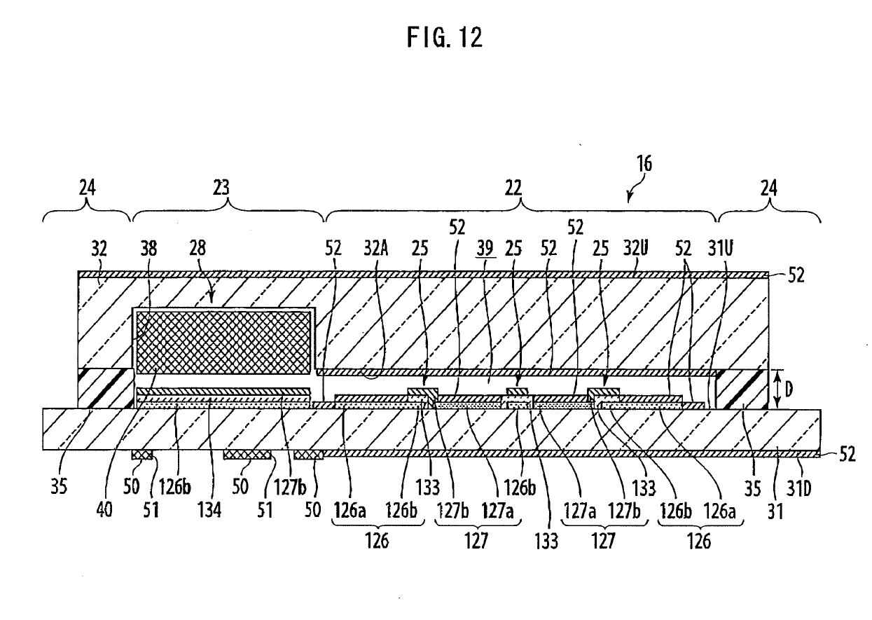

FIG. 12 shows the luminescent display device in the sixth embodiment. The luminescent display device 16 has the same structure as that of the second embodiment except for having an anti-reflective layer 52. The difference of this embodiment from the second embodiment will be explained below.

In this embodiment, the anti-reflective layer 52 is provided on both the upper and bottom surface 31U and 31D of the substrate 31 and the facing surface 31A and the upper surface 32U of the sealing member 32.

For example, on the bottom surface 31D of the substrate 31, the anti-reflective layer 52 is laminated on all or almost all of the photographing area 22 of the bottom surface 31D. On the upper surface 31U of the substrate 31, the anti-reflective layer 52 is laminated above almost all or all the upper surface 31U except for the area where the sealant 35 and the organic layer 133 and 134 are arranged. Namely, the anti-reflective layer 52 is laminated on the upper surface 31U, the upper surfaces of the anode and cathodes line 126a and 127a. Further, the anti-reflective layer 52 is laminated on almost all or all the facing surface 32A of the sealing member 32 except for the area where the recess 38 is arranged and the area where the sealant 35 is bonded, and is laminated on all or almost all of the upper surface 32U of the sealing member 32. The anti-reflective layer 52 is formed of MgF₂, silica aerogel, or others.

As described above, if the distance D between the sealing 5 member 32 and the substrate 31 is too short, interference fringes maybe generated. In this embodiment, the reflection at the substrate 31 and the sealing member 32 is reduced by the anti-reflective layer 52, which prevents the generation of interference fringes. Further, the transmittance quality of the substrate 31 and the sealing member 32 is improved by the anti-reflective layer 52, which improves the quality of the object image formed from the object light OL.

In this embodiment, it is not necessary to provide the anti-reflective layer 52 on all the surfaces 31U, 31D, 32A, and 32U. The anti-reflective layer 52 can be provided on at least one of the surfaces 31U, 31D, 32A, and 32U which cross the optical path of the object light OL. If the layer 52 is provided on one of the surfaces 31U, 31D, 32A, and 32U, the amplitude of the light reflected at the upper surface 31U of the substrate 31 is different from that of the light reflected at the facing surface 32A of the sealing member 32, which can weaken the contrast of the interference fringes and can reduce the occurrence of interference fringes.

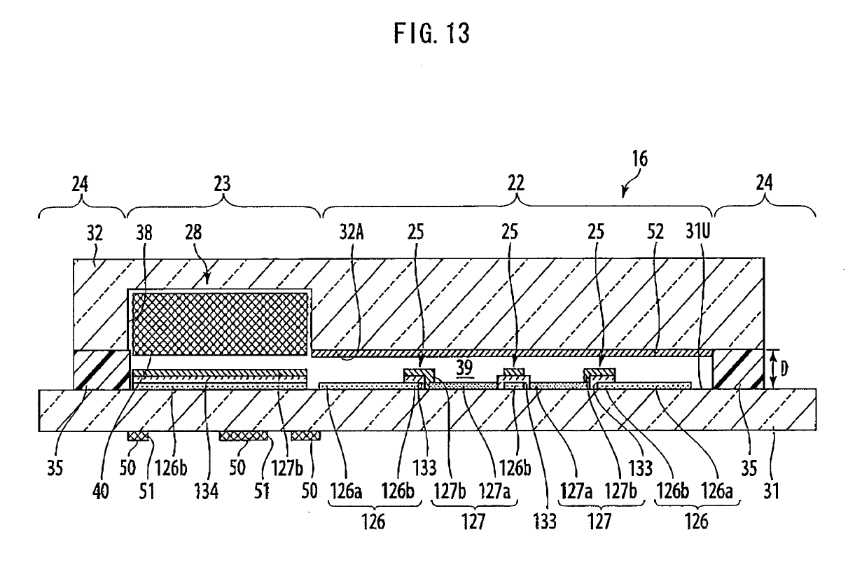

However, the anti-reflective layer is preferably provided on only the facing surface 32A of the sealing member 32, as shown in FIG. 13. In this case, the anti-reflective effect is higher than that in other cases where it is provided on other surfaces. Further, it is easy to laminate the anti-reflective layer 52 onto the facing surface 32A, because the organic layer is not laminated on the sealing member 32.

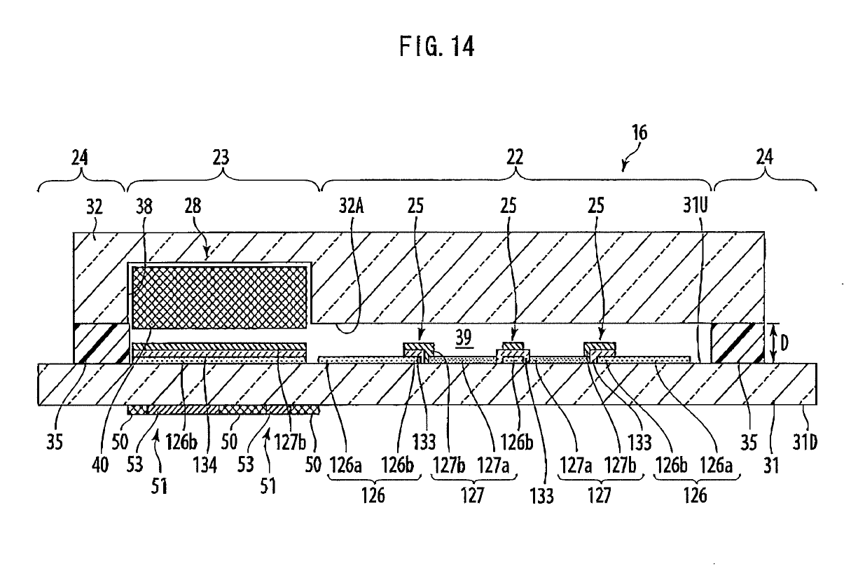

FIG. 14 shows the luminescent display device in the seventh embodiment. The luminescent display device 16 has the same structure as that of the second embodiment except for having a polarizing plate with a phase plate. The difference of this embodiment from the second embodiment will be explained below.

In this embodiment, the polarizing plate 53 with the phase plate is provided in the opening 51. An outside light which is incident into the luminescent display device 16 through the opening 51 is circularly polarized by the polarizing plate 53. A part of the incident outside light is reflected at the non-transparent electrode (the cathode terminal 127b). But the reflected outside light is not output to the outside of the device 16 because the reflected outside light is blocked out by the polarizing plate 53.

On the other hand, the light emitted by the second organic layer 134 including the light reflected at the cathode terminal 127b is output to the outside of the device 16 through the opening 51 (the polarizing plate 53). In this embodiment, the display contrast can be improved for the information display image area 23, which can give the information display a high level of visibility.

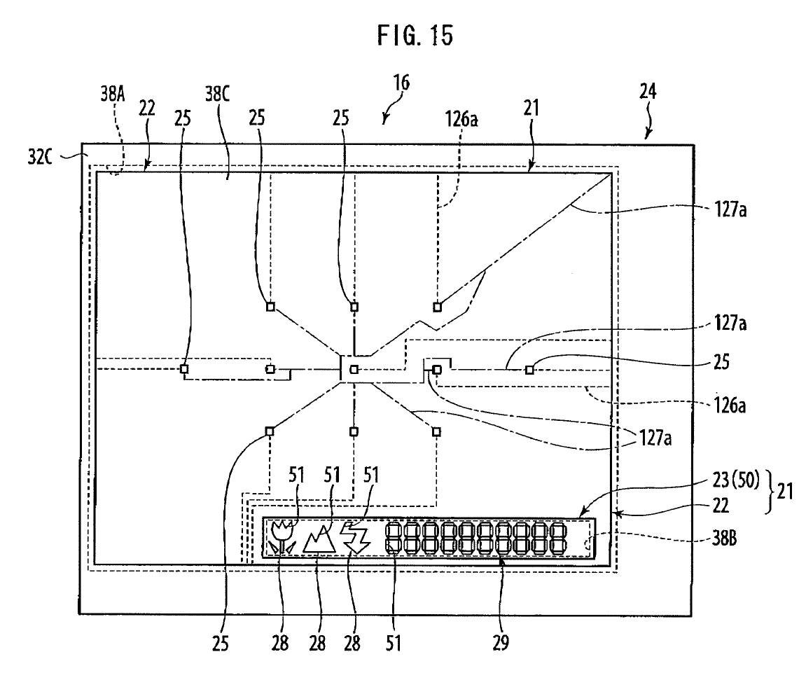

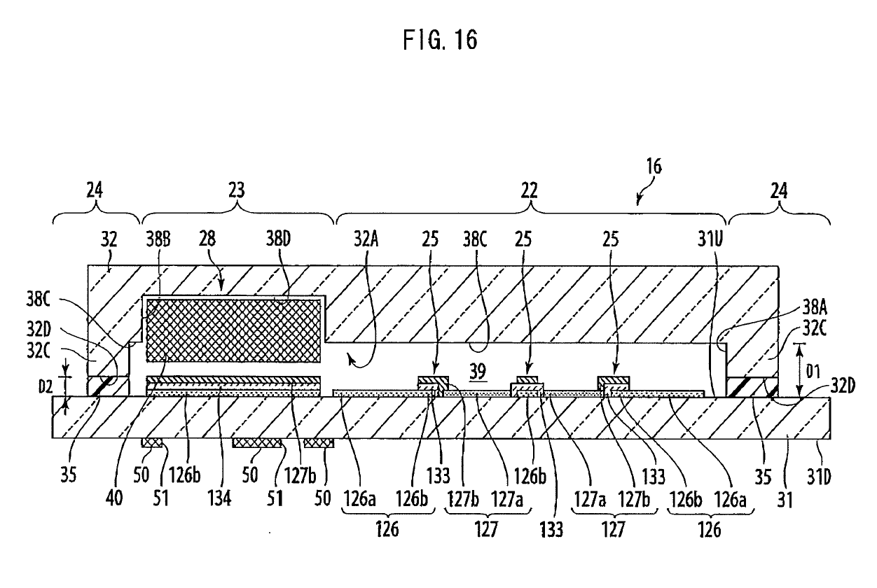

FIGS. 15 and 16 show the luminescent display device in the eighth embodiment. The difference between the second and eight embodiments is the structure of the recess. Next, the difference of this embodiment from the second embodiment will be explained.

In this embodiment, the sealing member has a first recess 38A and a second recess 38B. The first recess 38A is indented in the first facing surface 32A. The sealing member 32 has a surrounding portion, which surrounds the first recess 38A and is formed as a project 32C. The base surface 38C of the first recess 38A is a plan surface and is substantially parallel to the upper surface 31U of the substrate 31, and is a transmission surface. In view from the substrate side, the first recess 3SA is rectangular and the project 32C is in form of a rectangular frame. The top end 32D of the project 32C is bonded to the upper surface 31U by a sealant 35, so that the sealing space 39 is formed between the base surface 38C and the upper surface 31U of the substrate 31.

The second recess 38B is indented in the base surface 38C of the first recess 38A. The absorbent 40 is disposed within the second recess 38B. The second recess 38B overlaps onto the information display area 23, similar to the recess 38 of the second embodiment, so that the second organic layer 134, the anode terminal 126a, and the cathode terminal 127a are interposed between the absorbent 40 (the second recess 38B) and the substrate 31.

In view from the substrate side, as shown in FIG. 15, the photographing view area 22 is disposed within the first recess 36A; namely, the part of the first facing surface 32A corresponding to the photographing view area 22 is formed as the base surface 38C of the first recess 38A. The object light OL passes through the base surface 38C of the first recess 31A, and is output from the bottom surface 31D of the substrate 31. If the project 32C was arranged within the photographing view area 22, there would be a high possibility that an interference fringe could be generated. Therefore, the project 32C is arranged at the outside of the photographing view area 22.

The distance D1 between the upper surface 31U of the substrate 31 and the bottom surface 38C of the first recess 3BA is not less than 25 μm, for example. This relatively large distance D1 prevents the generation of an interference fringe, which can make the display contrast high.

On the other hand, the distance D2 between the top end 32D of the project 32C and the upper surface 31U of the substrate 31 can be relatively small, which allows bonding of the top end 32D to the substrate 31 directly with adhesive without the need for a spacer. The sealant 35 of the second embodiment has a spacer, which is bead** to both the substrate 31 and the sealing member 32, so that there are two interfaces between the substrate 31 and the sealing member 32 in the second embodiment. However, in this embodiment, there is only one interface between the substrate 31 and the sealing member 32, which means that the bonding area is small, which improves the air leakage efficiency in the sealing space 39.

The first and second recesses 38A and 383 are produced by an etching method, so that the base surfaces 38C and 38D of the first and second recesses 38A and 38B are a transmission surface. For example, a glass substrate in form of a plate is etched so as to form the first recess 38A. Next, the base surface 38C of the first recess 38A is etched so as to form the second recess 38B.

However, the base surface 38D may be a frosted surface. In this case, the second recess 38B may be produced by a blasting method. Furthermore, the first and second recesses may be formed when the sealing member is molded.

The second embodiment is modified so as to provide the eighth embodiment, but the 1^{st}-4^{th}, 6^{th}, and 7^{th} embodiments may also be modified so as to provide the eighth embodiment. Therefore, the second recess 383 may be composed of the first-third grooves 38X-38Z, similar to the third embodiment. Further, the second recess 38B may be in the form of a rectangular frame, in view from the substrate side.

Further, the second recess 38B is arranged within the viewfinder area 21 in this embodiment. However, a part or all of the second recess 385 may be arranged in the viewfinder out-of-view area 34 in this case, apart of the facing surface 32A of the sealing member 32 within the photographing view area 22 is formed as the first recess 38A. Further, the polarizing plate 53 of the seventh embodiment may be provided on the substrate 31. The anti-reflective layer 52 of the sixth embodiment may be provided on at least one of the substrate 31 and the sealing member 32.

In the 1^{st} to 8^{th} embodiments, each organic layer may have a single emitting layer so that the color of the emitted light can not be changed. However, each organic layer may have a plurality of emitting layers, so that the color of the emitted light can not be changed by altering the voltage applied to the organic layer. In this case, the emitting layers may be formed of different emitting materials from one another, or they may be doped with different dopant dyes from one another. Further, the color of the emitted light can be changed by changing the direction of the electric current which is input to the organic layer. In this case, the organic layer may have a hole-transporting layer, an emitting layer, a hole-blocking layer, another emitting layer, and an electron-transporting layer arranged in sequence from the anode side. In addition, another hole-blocking layer may be disposed between the hole-transporting layer and the emitting layer. Further, the organic layer may have a hole-transporting layer, a hole-blocking layer, an emitting layer, an electron-blocking layer, another emitting layer, 5 and an electron-transporting layer arranged in sequence from the anode side.

Although the embodiments of the present invention have been described herein with reference to the accompanying drawings, obviously many modifications and changes can be made by those skilled in this art without departing from the scope of the invention.

The present disclosure relates to subject matter contained in Japanese Patent Applications No. 2006-135216 (filed on May 15, 2006) and No. 2006-279697 (filed on Oct. 13, 2006) which are expressly incorporated herein, by references, in their entirety.

1. A luminescent display device, which is provided in a viewfinder device having a viewfinder window for observing an object, comprising:
a substrate;
a first electrode that is disposed on or above said substrate;
an organic layer including a light-emitting material that is disposed on or above at least a part of said first electrode;
a second electrode, at least a part of said second electrode being disposed over said organic layer, said organic layer caused to emit light by applying a voltage between said first and second electrode;
a sealing member that is disposed above said substrate so as to form a sealed space between said sealing member and said substrate, said organic layer and said first and second electrodes being disposed in said sealed space, the light of the image of said object being incident to said viewfinder window through said sealing member and said substrate, the light emitted by said organic layer being incident to said viewfinder window through one of said substrate and said sealing member so as to display an image that is observed at said viewfinder window; and
an absorbent that is disposed separately from said substrate within said sealed space, so that said organic layer is interposed between said substrate and said absorbent member.

2. A luminescent display device according to claim 1, wherein both said first and second electrodes comprise a transparent electrode portion formed of a transparent material.

3. A luminescent display device according to claim 1, wherein said light emitted by said organic layer is incident to said viewfinder window through said substrate.

4. A luminescent display device according to claim a, wherein said second electrodes comprise a non-transparent electrode portion formed of a non-transparent material, said non-transparent electrode portion interposed between said substrate and said absorbent member.

5. A luminescent display device according to claim 4, wherein said first electrode is an anode that is composed of said transparent electrode portion, and said second electrode is a cathode.

6. A luminescent display device according to claim 1, wherein said sealing member has a first facing surface that is orientated towards said substrate,
said sealing member having a recess that is formed in said first facing surface, said absorbent member being disposed in said recess.

7. A luminescent display device according to claim 6, wherein said recess is produced by a blasting method.

8. A luminescent display device according to claim 6, wherein said recess comprises first, second, and third straight grooves,
said second and third straight grooves extending substantially vertically to said first straight groove,
an end of said second straight groove connecting to one end of said first straight groove,
an end of said third straight groove connecting to the other end of said first straight groove.

9. A luminescent display device according to claim 1, wherein said sealing member has a first facing surface that is orientated towards said substrate, said substrate having a second facing surface that is orientated towards said first facing surface,
said sealing member having a first recess that is formed in said first facing surface, and a second recess that is formed in a base surface of said first recess,
said sealing member having a surrounding portion that surrounds said first recess, said surrounding portion bonding to said second facing surface so that said sealed space is formed between said base surface and said second facing surfaces.

10. A luminescent display device according to claim 9, wherein said first recess is produced by an etching method so that said base surface of said first recess is a transmission surface.

11. A luminescent display device according to claim 9, wherein said luminescent display device has a photographing view area through which the light of the image of said object is passed in order to observe said object,
a part of said sealing member corresponding to said photographing view area is formed as said first recess

12. A luminescent display device according to claim 1, wherein said luminescent display device has a viewfinder area that is viewable from said viewfinder window and a out-of-view area that is disposed outside said viewfinder area so that said out-of-view area is not viewable from said viewfinder,
said absorbent member arranged at least in said out-of-view area,

13. A luminescent display device according to claim 1, wherein said luminescent display device has a viewfinder area that is viewable from said viewfinder window,
the light that outputs from a part of said viewfinder area toward said viewfinder window being blocked by a shading member, said part of said viewfinder area defined as a shading area, said absorbent member arranged at least in said shading area.

14. A luminescent display device according to claim 13, wherein said shading member comprises an opening formed in a predetermined shape,
said organic layer arranged at least in said shading area,
a part of the light that is emitted by said organic layer being made incident to said viewfinder window through said opening, said part of the light displayed being an information image visible in said viewfinder window.

15. A luminescent display device according to claim 14, wherein a polarizing plate with a phase plate is provided in said opening.

16. A luminescent display device according to claim 1, wherein a distance between said sealing member and said substrate is not less than 25 μm.

17. A luminescent display device according to claim 1, wherein said absorbent is formed of a transparent material.

18. A luminescent display device according to claim 17, wherein said both first and second electrodes comprise a transparent electrode formed of a transparent material, said transparent electrode interposed between said substrate and said absorbent member.

19. A luminescent display device according to claim 1, wherein said sealing member has a first facing surface that is orientated towards said substrate and a first opposite surface that is an opposite surface to said first facing surface, and said substrate has a second facing surface that is orientated towards said first facing surface and a second opposite surface that is an opposite surface to said second facing surface,
an anti-reflective layer laminated on at least one of said first and second facing surfaces and said first and second opposite surfaces.

20. A luminescent display device according to claim 19, wherein said anti-reflective layer is laminated on said first facing surface.

21. A luminescent display device, which is provided in a viewfinder device having a viewfinder window for observing an object, comprising;
a substrate;
a first electrode that is disposed on or above said substrate;
an organic layer including a light-emitting material that is disposed on or above at least a part of said first electrode;
a second electrode, at least a part of said second electrode being disposed on or above said organic layer, said organic layer being caused to emit a light by applying a voltage between said first and second electrodes;
a sealing member that is disposed above said substrate so as to form a sealed space between said sealing member and said substrate, said organic layer and said first and second electrodes disposed in said sealed space, the light of the image of said object being incident to said viewfinder window through said sealing member and said substrate, the light emitted by said organic layer being incident to said view finder window through one of said substrate and said sealing member so as to display an image that is observed at said viewfinder window; and
an absorbent that is disposed within said sealed space,
wherein said luminescent display device has a viewfinder area that is viewable from said viewfinder window and an out-or-view area that is disposed outside said viewfinder area so that said out-of-view area is not viewable from said viewfinder window, said absorbent being arranged in said out-of-view area.

22. A luminescent display device, which is provided in a viewfinder device having a viewfinder window for observing an object, comprising:
a substrate;
a first electrode that is disposed on or above said substrate;
an organic layer including a light-emitting material that is disposed on or above at least a part of said first electrode;
a second electrode, at least a part of said second electrode being disposed on or above said organic layer, said organic layer being caused to emit a light by applying a voltage between said first and second electrodes;
a sealing member that is disposed above said substrate so as to form a sealed space between said sealing member and said substrate, said organic layer and said first and second electrodes disposed in said sealed space, the light of the image of said object being incident to said viewfinder window through said sealing member and said substrate, the light emitted by said organic layer being incident to said viewfinder window through one of said substrate and said sealing member so as to display an image that is observed at said viewfinder window; and
an absorbent that is disposed within said sealed space,
wherein said luminescent display device has a viewfinder area that is viewable from said viewfinder window, a light that outputs from a part of said viewfinder area toward said viewfinder window being obstructed by a shading member, said part of said viewfinder area defined as a shading area, said absorbent member being arranged in said shading area.

23. A viewfinder device, which is provided with a luminescent display device, and a viewfinder window for observing an object, said luminescent display device comprising:
a substrate;
a first electrode that is disposed on or above said substrate;
an organic layer including a light-emitting material that is disposed on or above at least a part of said first electrode;
a second electrode, at least a part of said second electrode being disposed on or above said organic layer, said organic layer being caused to emit light by applying a voltage between said first and second electrodes;
a sealing member that is disposed above said substrate so as to form a sealed space between said sealing member and said substrate, said organic layer and said first and second electrodes being disposed in said sealed space, the light of the image of said object being incident to said viewfinder window through said sealing member and said substrate, the light emitted by said organic layer being incident to said viewfinder window through one of said substrate and said sealing member so as to display an image that is observed at said viewfinder window; and
an absorbent that is disposed separately from said substrate within said sealed space, so that said organic layer is interposed between said substrate and said absorbent member.

24. A viewfinder device, which is provided with a luminescent display device, and a viewfinder window for observing an object, said luminescent display device comprising:
a substrate;
a first electrode that is disposed on or above said substrate;
an organic layer including a light-emitting material that is disposed on or above at least a part of said first electrode;
a second electrode, at least a part of said second electrode being disposed on or above said organic layer, said organic layer being caused to emit a light by applying a voltage between said first and second electrode;
a sealing member that is disposed above said substrate so as to form a sealed space between said sealing member and said substrate, said organic layer and said first and second electrodes being disposed in said sealed space, the light of the image of said object being incident to said viewfinder window through said sealing member and said substrate, the light emitted by said organic layer being incident to said viewfinder window through one of said substrate and said sealing member so as to display an image that is observed at said viewfinder window; and
an absorbent that is disposed within said sealed space,
wherein said luminescent display device has a viewfinder area that is viewable from said viewfinder window and a out-of-view area that is disposed outside said viewfinder area so that said out-of-view area is not viewable from said viewfinder window, said absorbent being arranged in said out-of-view area.

25. A viewfinder device, which is provided with a luminescent display device, and a viewfinder window for observing an object, said luminescent display device comprising:
a substrate;
a first electrode that is disposed on or above said substrate;
an organic layer including a light-emitting material that is disposed on or above at least a part of said first electrode;
a second electrode, at least a part of said second electrode being disposed on or above said organic layer, said organic layer being caused to emit a light by applying a voltage between said first and second electrodes;
a sealing member that is disposed above said substrate so as to form a sealed space between said sealing member and said substrate, said organic layer and said first and second electrodes being disposed in said sealed space, the light of the image of said object being incident to said viewfinder window through said sealing member and said substrate, the light emitted by said organic layer being incident to said viewfinder window through one of said substrate and said sealing member so as to display an image that is observed at said viewfinder window; and
an absorbent that is disposed within said sealed space,
wherein said luminescent display device has a viewfinder area that is viewable from said viewfinder window, light that outputs from a part of said viewfinder area toward said viewfinder window being obstructed by a shading member, said part of said viewfinder area defined as a shading area, said absorbent member being arranged in said shading area.

26. An optical device, which is provided with a viewfinder device having a luminescent display device and a viewfinder window for observing an object, said luminescent display device comprising:
a substrate;
a first electrode that is disposed on or above said substrate;
an organic layer including a light-emitting material that is disposed on or above at least a part of said first electrode;
a second electrode, at least a part of said second electrode being disposed on or above said organic layer, said organic layer being cause to emit light by applying a voltage between said first and second electrodes;
a sealing member that is disposed above said substrate so as to form a sealed space between said sealing member and said substrate, said organic layer and said first and second electrodes being disposed in said sealed space, the light of the image of said object being incident to said viewfinder window through said sealing member and said substrate, the light emitted by said organic layer being incident to said viewfinder window through one of said substrate and said sealing member so as to display an image that is observed at said viewfinder window; and
an absorbent that is disposed separately from said substrate within said sealed space, so that said organic layer is interposed between said substrate and said absorbent member.

27. An optical device, which is provided with a viewfinder device having s luminescent display device and a viewfinder window for observing an object, said luminescent display device comprising:
a substrate;
a first electrode that is disposed on or above said substrate;
an organic layer including a light-emitting material that is disposed on or above at least a part of said first electrode;
a second electrode, at least a part of said second electrode being disposed on or above said organic layer, said organic layer being caused to emit light by applying a voltage between said first and second electrodes;
a sealing member that is disposed above said substrate so as to form a sealed space between said sealing member and said substrate, said organic layer and said first and second electrodes disposed in said sealed space, the light of the image of said object being incident to said viewfinder window through said sealing member and said substrate, the light emitted by said organic layer being incident to said viewfinder window through one of said substrate and said sealing member so as to display an image that is observed at said viewfinder window; and
an absorbent that is disposed within said sealed space,
wherein said luminescent display device has a viewfinder area that is viewable from said viewfinder window and an out-of-view area that is disposed outside said viewfinder area so that said out-of-view area is not viewable from said viewfinder, said absorbent being arranged in said out-of-view area.

28. An optical device, which is provided with a viewfinder device having a luminescent display device and a viewfinder window for observing an object, said luminescent display device comprising:
a substrate;
a first electrode that is disposed on or above said substrate;
an organic layer including a light-emitting material that is disposed on or above at least a part of said first electrode;
a second electrode, at least a part of said second electrode being disposed over said organic layer, said organic layer being caused to emit light by applying a voltage between said first and second electrodes;
a sealing member that is disposed above said substrate so as to form a sealed space between said sealing member and said substrate, said organic layer and said first and second electrodes disposed in said sealed space, the light of the image of said object being incident to said viewfinder window through said sealing member and said substrate, the light emitted by said organic layer being incident to said viewfinder window through one of said substrate and said sealing member so as to display an image that is observed at said viewfinder window; and
an absorbent that is disposed within said sealed space, wherein said luminescent display device has a viewfinder area that is viewable from said viewfinder window, a light that outputs from a part of said viewfinder area toward said viewfinder window being obstructed by a shading member, said part of said viewfinder area defined as a shading area, said absorbent member being arranged in said shading area.
